(19) United States
(12) Patent Application Publication
(10) Pub. No.: US 2010/0092865 A1
(43) Pub. Date: Apr. 15, 2010

(54) CARBON COMPOSITE MATERIALS AND PROCESS FOR PRODUCTION THEREOF

(75) Inventors: Ryoji Kanno, Yokohama-shi (JP); Michiko Otani, Kobe-shi (JP); Sho Kanzaki, Niihama-shi (JP); Yoshihiro Kawakami, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignees: Tokyo Institute of Technology, Meguro-ku, Tokyo (JP); Sumitomo Chemical Company, Limited, Chuo-ku, Tokyo (JP)

(21) Appl. No.: 12/521,264

(22) PCT Filed: Dec. 27, 2007
(86) PCT No.: PCT/JP2007/075067

§ 371 Date: Sep. 24, 2009

(30) Foreign Application Priority Data
Dec. 27, 2006 (JP) 2006-351838

(51) Int. Cl. H01M 4/48; H01M 4/29; C25D 7/00

(52) U.S. Cl. 429/221; 205/66; 205/50

(57) ABSTRACT

The invention provides materials capable of giving electrodes having the smaller rate of the capacity loss due to an irreversible capacity in the initial cycle in the charge and discharge cycle test as compared with electrodes comprising conventional materials; and a process for the production thereof. A carbon composite material comprising a carbon material and a metal oxide coating on the surface of the carbon material, wherein the metal oxide is an Fe-containing metal oxide; a carbon composite material, wherein the above-described carbon material is mesoporous carbon; a carbon composite material, wherein the above-described Fe-containing metal oxide is Fe₂O₃; and a process for the production of the carbon composite material comprising the steps (a) and (b): (a) the step of obtaining an Fe-coated carbon material by coating a surface of a carbon material with Fe by an electrolysis using an anode, a cathode with a carbon material disposed on the surface thereof, and an electrolytic solution comprising an aqueous solution containing Fe; and (b) the step of heating the Fe-coated carbon material in an oxygen-containing atmosphere.

### TECHNICAL FIELD

The present invention relates to a carbon composite material and a process for production thereof, in particular, to a carbon composite material used for electrodes and a process for production thereof.

### BACKGROUND ART

Carbon materials are used for electrodes for electric power storage such as in secondary batteries, capacitors and fuel cells. As the electrode comprising a carbon material, Patent Document 1 discloses an electrode comprising a mesoporous carbon.

### PATENT DOCUMENT 1: JP-A-2005-166325

### DISCLOSURE OF THE INVENTION

### Problems to be Solved by the Invention

In the secondary batteries produced by using electrodes comprising conventional carbon materials, however, there is a problem that larger is the rate of the capacity loss due to the irreversible capacity in the initial cycle in a charge-discharge cycle test of the secondary batteries. An object of the present invention is to provide a material capable of giving electrodes having a smaller rate of the capacity loss due to the irreversible capacity in the initial cycle in the charge-discharge cycle test, as compared with conventional materials and to provide a process for production of the carbon composite material.

### Means for Solving the Problems

As a result of various investigations, the present inventors have reached the present invention by discovering that the following aspects of the present invention are in conformity with the above-described object. Specifically, the present invention provides the following aspects.

(1) A carbon composite material comprising a carbon material and a metal oxide coating on a surface of the carbon material, wherein the metal oxide is an Fe-containing metal oxide.

(2) The carbon composite material according to (1), wherein the carbon material is a mesoporous carbon.

(3) The carbon composite material according to (1) or (2), wherein the Fe-containing metal oxide is Fe₂O₃.

(4) The carbon composite material according to any one of (1) to (3), wherein a BET specific surface area of the carbon composite material is 400 m²/g to 1000 m²/g.

(5) The carbon composite material according to any one of (1) to (4), wherein the carbon composite material has pores and an average diameter of the pores is 1 nm to 10 nm.

(6) A process for production of the carbon composite material according to any one of (1) to (5) comprising the following steps of (a) and (b):

(a) a step of obtaining an Fe-coated carbon material by coating a surface of a carbon material with Fe by an electrolysis using an anode, a cathode with the carbon material disposed on the surface thereof, and an electrolytic solution comprising an Fe-containing aqueous solution; and

(b) a step of heating the Fe-coated carbon material in an oxygen-containing atmosphere.

(7) The process for production according to (6), wherein the anode and the cathode are each an Al plate.

(8) An electrode comprising the carbon composite material according to any one of (1) to (5) or the carbon composite material obtained by the process for production according to (6) or (7).

### Effects of the Invention

According to the carbon composite material of the present invention, it is possible to obtain electrodes having a smaller rate of the capacity loss due to the irreversible capacity in the initial cycle in the charge-discharge cycle test, as compared with the electrodes comprising conventional carbon materials. Accordingly, the carbon composite materials are suitably usable in secondary batteries, in particular, nonaqueous electrolytic solution secondary batteries such as lithium ion secondary batteries, and are also usable in electrodes for capacitors and in electrodes for fuel cells; thus the present invention is industrially extremely useful.

### BEST MODE FOR CARRYING OUT THE INVENTION

The present invention provides a carbon composite material comprising a carbon material and a metal oxide coating on a surface of the carbon material, wherein the metal oxide is an Fe-containing metal oxide.

In the sense that the effects of the present invention are more enhanced, the BET specific surface area of the carbon material in the present invention is preferably larger. Examples of the preferable carbon material having a larger BET specific surface area may include a mesoporous carbon. The mesoporous carbon is a carbon material that three-dimensionally has pores uniform in size and regular in arrangement. When the mesoporous carbon is used as the carbon material, even the carbon material surface in the pores is able to be coated with the Fe-containing metal oxide. When a carbon composite material obtained by using the mesoporous carbon as the carbon material is used for electrodes, the capacity enhancement of the electrodes and uniform electrode reactions are made realizable.

The mesoporous carbon can be obtained as follows: a mesoporous oxide, namely, an oxide (for example, mesoporous silica) that three-dimensionally has pores uniform in size and regular in arrangement is used as a base material, an organic substance as a carbon source such as sugar and sucrose is filled in the pores, the mesoporous oxide is then heated in an atmosphere of an inert gas such as nitrogen and a rare gas to carbonize the organic substance, and further the base material is dissolved with an acid such as hydrofluoric acid or an alkali aqueous solution such as an aqueous solution of sodium hydroxide. Mesoporous carbons made to support particles of metals such as Pt and Ru with an impregnation method or the like and mesoporous carbons high in graphitization degree may also be used.

In the present invention, examples of the Fe-containing metal oxide include iron (II) oxide FeₓO (x=0.91 to 0.95), iron (III) oxide Fe₂O₃ and diiron(III) iron(II) oxide Fe₃O₄, and the Fe-containing metal oxide is preferably iron (III) oxide Fe₂O₃. Of the Fe₂O₃ species, γ-Fe₂O₃ is more preferable. By adopting preferable Fe₂O₃ and more preferable γ-Fe₂O₃ as the Fe-containing metal oxide, the thus obtained carbon composite material enables to enhance the capacity of an electrode when the carbon composite material is used for the electrode.

The BET specific surface area of the carbon composite material of the present invention is preferably 400 m²/g to 1000 m²/g and more preferably 400 m²/g to 700 m²/g. By setting the BET specific surface area as described above, the thus obtained carbon composite material enables to enhance the capacity of an electrode when the carbon composite material is used for the electrode. Additionally, the BET specific surface area can be controlled by controlling the number of the operations of the below-described production step (a) and/or the Fe concentration in the Fe-containing aqueous solution. Specifically, with the increase of the number of the operations, the BET specific surface area becomes smaller, and with the increase of the Fe concentration, the BET specific surface area becomes smaller.

The carbon composite material of the present invention preferably has pores, and when this is the case, the average diameter of the pores is 1 nm to 10 nm and more preferably 2 nm to 4 nm. By setting the average diameter of the pores as described above, the thus obtained carbon composite material enables to enhance the capacity of an electrode when the carbon composite material is used for the electrode.

The BET specific surface area and the average diameter of the pores in the present invention can be determined by using a nitrogen adsorption isotherm obtained by making a sample adsorb nitrogen gas while the sample (carbon material, or carbon composite material) is set at the liquid nitrogen temperature. Specifically, the BET specific surface area of the sample can be determined by using the nitrogen adsorption isotherm, on the basis of the Brunauer-Emmett-Teller (BET) method, and additionally, the average diameter of the pores of the sample can be determined by using the nitrogen adsorption isotherm, on the basis of the Barrett-Joyner-Halenda (BJH) method. For the purpose of determining these values, the measurements may be made by using as a measurement apparatus, for example, an automatic specific surface area/pore size distribution measurement apparatus (BELSORP-mini II) manufactured by BEL Japan, Inc.

In the present invention, the Fe-containing metal oxide is preferably coated on the surface of the carbon material in a layered manner. By being coated in a layered manner, the thus obtained carbon composite material enables to allow the electrode reaction to proceed uniformly when the carbon composite material is used for the electrode. However, as long as the effects of the present invention are not impaired, the portions that are not coated with the metal oxide may be present; for example, when a mesoporous carbon is used, non-coated portions may be present on the outer surface and/or the interior of the pores. Whether or not the metal oxide is present in a manner that coats at least a portion of the carbon material can be determined on the basis of the decrease of the pore volume and/or the decrease of the surface area after the coating with the metal oxide; when such decrease is found, the metal oxide can be identified to be present in a manner that coats the carbon material.

Additionally, in the present invention, the weight of the Fe-containing metal oxide to the weight (100 parts by weight) of the carbon composite material is usually 1 part by weight to 80 parts by weight and is preferably 5 parts by weight to 50 parts by weight in the sense of favorably adopting the present invention.

Next, the process for production of the carbon composite material of the present invention is described.

The carbon composite material of the present invention can be produced by a process including the following steps (a) and (b):

(a) a step of obtaining an Fe-coated carbon material by coating a surface of a carbon material with

Fe by an electrolysis using an anode, a cathode with the carbon material disposed on the surface thereof, and an electrolytic solution comprising an Fe-containing aqueous solution are used; and

(b) a step of heating the Fe-coated carbon material in an oxygen-containing atmosphere.

The step (a) is a so-called plating method. In the step (a), for the obtained Fe-coated carbon material, the same electrolysis operation as the step (a) may be repeated. Specifically, this repetition is implemented as the following step (a′). By repeating the step (a′), the coating thickness and the BET specific surface area of the obtained carbon composite material become adjustable.

(a′) A step of obtaining a further-Fe-coated carbon material by coating the surface of the Fe-coated carbon material with Fe by an electrolysis in which an anode, a cathode with the carbon material disposed on the surface thereof, and an electrolytic solution comprising an Fe-containing aqueous solution are used.

In the step (a), from the viewpoint of operation, the carbon material to be disposed on the surface of the cathode is preferably molded into a pellet shape. In this case, in the step (a), the Fe-coated carbon material thus obtained is of a pellet shape, and in the step (b), the Fe-coated carbon material is preferred to be converted into a powdery form by pulverization or the like before heating. Additionally, for the anode and cathode, Al plates may be used.

Examples of the Fe-containing aqueous solution in the above description may include an iron chloride aqueous solution, an iron nitrate aqueous solution and an iron sulfate aqueous solution; the mixed solutions of these may also be used.

Additionally, the Fe concentration of the Fe-containing aqueous solution is usually 0.5 mol/L to 10 mol/L and preferably 1 mol/L to 5 mol/L.

Additionally, the electrolysis in the above description is usually conducted in such a way that a separately-arranged electric power source is used, the plus electrode of the electric power source and the anode is electrically connected to each other and the minus electrode of the electric power source and the cathode is electrically connected to each other. The other plating conditions such as the electric power application time and the electric power application amount are experimentally appropriately determined, and general-purpose additives and the like may also be added to the plating bath where necessary, the amounts of such additives being also experimentally appropriately determined.

Additionally, the Fe-coated carbon material obtained as described above may be washed before heating in the step (b). The impurities such as superfluous metal ions and anions can be removed by washing. The washing may be conducted once or more with water, water-alcohol, acetone or the like.

In the step (b), the heating temperature is preferably 100° C. or higher and 350° C. or lower and more preferably 250° C. or higher and 300° C. or lower. The time maintained at the heating temperature is usually 1 to 5 hours and preferably 1 to 2 hours. Additionally, the atmosphere for the heating is preferably an oxygen-containing atmosphere such as oxygen and air.

Next, the electrode including the carbon composite material of the present invention is described by quoting as examples the electrodes (positive electrode and negative electrode) for nonaqueous electrolyte secondary batteries typified by lithium ion secondary batteries.

The positive electrode for a nonaqueous electrolyte secondary battery is produced by supporting a positive electrode mixture containing a positive electrode active material and a binder on a positive electrode current collector. A conducting aid may be further included in the positive electrode mixture. As the conducting aid, a carbon material may be used, and examples of the carbon material may include graphite powder, carbon black and acetylene black. Usually, the proportion of the conducting aid in the positive electrode mixture is 1% by weight or more and 30% by weight or less. The carbon composite material of the present invention can be used as the positive electrode active material or the conducting aid.

As the binder, thermoplastic resins can be used. Specific examples of the thermoplastic resins include: fluororesins such as polyvinylidene fluoride (hereinafter, it may be referred to as PVDF), polytetrafluoroethylene (hereinafter, it may be referred to as PTFE), ethylene tetrafluoride-propylene hexafluoride-vinylidene fluoride copolymer, propylene hexafluoride-vinylidene fluoride copolymer and ethylene tetrafluoride-perfluorovinyl ether copolymer; and polyolefin resins such as polyethylene and polypropylene. These resins may be used as mixtures of two or more thereof. The proportion of the binder to the positive electrode mixture is usually 1% by weight or more and 10% by weight or less.

For the positive electrode current collector, Al, Ni, stainless steel and the like may be used, Al being preferable because Al is easily processed into thin film and is low in price. Examples of a method for supporting the positive electrode mixture on the positive electrode current collector include a method in which pressure molding is applied and a method in which the positive electrode mixture is converted into a paste by using an organic solvent or the like, the paste is applied to the positive electrode current collector, and the applied paste is dried and then subjected to pressing or the like to be fixed to the positive electrode current collector. At the time of conversion into the paste, a slurry comprising a positive electrode active material, a conducting material, a binder and an organic solvent is prepared. Examples of the organic solvent include: amine solvents such as N,N-dimethylaminopropylamine and diethylenetriamine; ether solvents such as tetrahydrofuran; ketone solvents such as methyl ethyl ketone; ester solvents such as methyl acetate; and amide solvents such as dimethylacetamide and 1-methyl-2-pyrrolidone.

Examples of the method of coating the positive electrode current collector with the positive electrode mixture include a slit die coating method, a screen coating method, a curtain coating method, a knife coating method, a gravure coating method and an electrostatic spray method. By applying these quoted methods, the positive electrode for a nonaqueous electrolyte secondary battery can be produced.

By using the positive electrode for a nonaqueous electrolyte secondary battery, a nonaqueous electrolyte secondary battery can be produced as follows. Specifically, a separator, a negative electrode produced by supporting a negative electrode mixture on a negative electrode current collector, and the above-described positive electrode are laminated with each other and wound to produce an electrode assembly, and the electrode assembly thus obtained is put in an battery can, and thereafter an electrolytic solution comprising an organic solvent containing an electrolyte is impregnated into the electrode assembly, and thus a nonaqueous electrolyte secondary battery can be produced.

Examples of the shape of the electrode group may include a circle, an ellipse, a rectangle and a rectangle with round corners, in terms of the cross section formed by cutting the electrode group in the direction perpendicular to the winding axis of the electrode group. Additionally, examples of the shape of the battery may include a paper shape, a coin shape, a cylinder shape and a cuboid shape.

Examples of the negative electrode include a negative electrode formed by supporting the negative electrode mixture that contains a lithium ion dopable/dedopable material on the negative electrode current collector and a negative electrode formed of lithium metal or a lithium alloy. Specific examples of the lithium ion dopable/dedopable material include carbon materials such as natural graphite, artificial graphite, coke, carbon black, pyrolyzed carbon, carbon fiber and calcined products of organic polymer compounds. The shapes of the carbon materials may be any of the following shapes: a flaky shape such as the shape of natural graphite, a spherical shape such as the shape of a mesoporous carbon, a fibrous shape such as the shape of graphitized carbon fiber, or an aggregate of a fine powder. The carbon composite material of the present invention can be used as a lithium ion dopable/dedopable material.

Alternatively, as the lithium ion dopable/dedopable material, chalcogen compounds including oxides and sulfides may also be used. Examples of the chalcogen compounds include chalcogen compounds such as crystalline or amorphous oxides and sulfides mainly comprising the elements of Groups 13, 14 and 15 in the periodic table; specific examples of the chalcogen compounds include amorphous compounds mainly comprising tin oxide. In the case where the electrolytic solution does not contain below-described ethylene carbonate, when a negative electrode mixture that contains polyethylene carbonate is used, the cycle property and the large-current discharge property of the obtained secondary battery may be improved.

The negative electrode mixture may contain, where necessary, a binder. Examples of the binder may include thermoplastic resins; specific examples of the binder may include PVDF, thermoplastic polyimide, carboxymethyl cellulose, polyethylene and polypropylene. Additionally, the negative electrode mixture may include, where necessary, a conducting material. The carbon composite material of the present invention can be used as the conducting material.

Examples of the material for the negative electrode current collector may include Cu, Ni and stainless steel, and Cu is preferably used because Cu hardly forms an alloy with lithium and is easily processed into thin film. Examples of a method for supporting the negative electrode mixture on the negative electrode current collector include, in the same manner as in the case of the positive electrode, a method in which pressure molding is applied and a method in which the negative electrode mixture is converted into a paste by using a solvent or the like, the paste is applied to the negative electrode current collector, and the applied paste is dried and then subjected to pressing to be pressure-fixed to the negative electrode current collector.

Examples of the materials usable for the separator include the materials having the forms such as porous film, nonwoven fabric and woven fabric comprising the materials such as polyolefin resins including polyethylene and polypropylene, fluororesins and nitrogen-containing aromatic polymers; alternatively, the separator may be formed by using two or more of these materials, and may be a laminated separator formed by laminating two or more layers comprising different materials. As the laminated separator, a laminated separator formed by laminating a nitrogen-containing aromatic polymer layer and a polyethylene layer is preferable as a separator for use in a secondary battery from the viewpoints of the heat resistance and the shut-down performance. Examples of the separator may include the separators described in JP-A-2000-30686 and JP-A-10-324758. The thickness of the separator is preferably made thinner as long as the mechanical strength of the separator is maintained, from the viewpoints that the volume energy density of the battery is increased and that the internal resistance of the battery is decreased; thus, the thickness of the separator is usually about 10 to 200 and preferably about 10 to 30 μm.

Examples of the electrolyte in the electrolytic solution include lithium salts such as

LiClO₄, LiPF₆, LiAsF₆, LiSbF₆, LiBF₄, LiCF₃SO₃, LiN (SO₂CF₃)₂, LiC (SO₂CF₃)₃, Li₂B₁₀Cl₁₀, lithium salts of lower aliphatic carboxylic acids and LiAlCl₄; and the mixtures of two or more of these may also be used. Usually, used is the electrolytic solution that contains as the lithium salt at least one selected from the group consisting of LiPF₆, LiAsF₆, LiSbF₆, LiBF₄, LiCF₃SO₃, LiN (SO₂CF₃)₂ and LiC (SO₂CF₃)₃.

Additionally, examples of the organic solvent usable in the electrolytic solution include: carbonates such as propylene carbonate, ethylene carbonate, dimethyl carbonate, diethyl carbonate, ethyl methyl carbonate, 4-trifluoromethyl-1,3-dioxolan-2-one and 1,2-di(methoxycarbonyloxy)ethane; ethers such as 1,2-dimethoxyethane, 1,3-dimethoxypropane, pentafluoropropyl methyl ether, 2,2,3,3-tetrafluoropropyl difluoromethyl ether, tetrahydrofuran and 2-methyltetrahydrofuran; esters such as methyl formate, methyl acetate and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide and 1,3-propanesultone; and the organic solvents obtained by further introducing a fluorine substituent into these organic solvents. Usually, used are the mixtures of two or more of these organic solvents. Among such organic solvents, preferable are the mixed solvents that contain carbonates; furthermore preferable is a mixed solvent comprising a cyclic carbonate and an acyclic carbonate or a mixed solvent comprising a cyclic carbonate and an ether. As the mixed solvent comprising cyclic carbonates and acyclic carbonates, preferable is a mixed solvent composed of ethylene carbonate, dimethyl carbonate and ethyl methyl carbonate because this mixed solvent has wide range in the operation temperature, and is excellent in the load characteristics, and hardly decomposable even when a graphite material such as natural graphite and artificial graphite is used as a negative electrode active material. Additionally, it is also preferable to use an electrolytic solution that contains a fluorine-containing lithium salt such as LiPF₆ and a fluorine substituent-containing organic solvent in terms of attaining a particularly excellent safety improvement effect is attained. A mixed solvent that contains a fluorine substituent-containing ether such as pentafluoropropyl methyl ether or 2,2,3,3-tetrafluoropropyl difluoromethyl ether and dimethyl carbonate is excellent also in large-current discharge property and hence is more preferable.

In place of the electrolytic solution, a solid electrolyte may also be used. Examples of the usable solid electrolyte include polymer electrolytes such as polyethylene oxide polymer compounds, polymer compounds that contain at least one or more of polyorganosiloxane chains or polyoxyalkylene chains. Additionally, also usable is a so-called gel-type electrolyte in which a polymer holds a nonaqueous electrolyte solution. Alternatively, when the sulfide electrolytes such as Li₂S—SiS₂, Li₂S—GeS₂, Li₂S—P₂S₅ and Li₂S—B₂S₃ or the sulfide-containing inorganic compound electrolytes such as Li₂S—SiS₂—Li₃PO₄ and Li₂S—SiS₂—Li₂SO₄ are used, the safety may be more enhanced.

In the above descriptions, as the electrode comprising the carbon composite material of the present invention, shown are the examples of the electrodes for nonaqueous electrolyte secondary batteries typified by the lithium ion secondary batteries; however, examples of other electrodes may include electrodes for aqueous electrolytic solution secondary batteries such as nickel-cadmium secondary batteries and a nickel-metal hydride secondary batteries, electrodes for capacitors and electrodes for use in fuel cells. These electrodes may be produced by the common techniques.

Specifically, these electrodes can be produced by using the carbon composite material of the present invention, and for example, by adopting the techniques as disclosed in JP-A-8-315810 and JP-A-2004-014427 in the cases of the electrodes for aqueous electrolytic solution secondary batteries, the technique as disclosed in JP-A-2000-106327 in the case of the electrodes for capacitors, and the technique as disclosed in JP-A-2006-331786 in the case of the electrodes for fuel cells.

### EXAMPLE

Next, the present invention is described in more detail with reference to Example. It is to be noted that for the measurements of the BET specific surface area and the average diameter of the pores of a carbon material and a carbon composite material, an automatic specific surface area/pore size distribution measurement apparatus (BELSORP-mini II) manufactured by BEL Japan, Inc. was used.

### Production Example 1 (Production of a Carbon Material)

As a carbon material, a mesoporous carbon was produced by the following process.

In a beaker, 2 g of a surfactant (neutral block copolymer, HO (CH₂CH₂O)₂₀ (CH₂CH (CH₃)O)₇₀ (CH₂CH₂O)₂₀H, product of Aldrich Corp.), 10 ml of 36% hydrochloric acid and 65 ml of distilled water were placed and mixed together; further 3 ml of tetramethoxy orthosilicate (TMOS, manufactured by Kanto Chemical Co., Inc.) was placed in the beaker, stirred at a temperature set at 40° C. for 20 hours, and then the reaction mixture was allowed to stand still at a temperature set at 80° C. for one day and filtered, and the filtered solid content was washed and dried to yield a solid content. The solid content was calcined in air at 550° C. for 5 hours to yield a mesoporous silica (SP1). To 1 g of the obtained mesoporous silica (SP1), 1.25 g of sucrose (Wako Pure Chemical Industries, Ltd.), 0.14 g of 97% sulfuric acid and 5 ml of distilled water were added, the mixture thus obtained was heated at 100° C. for 6 hours, and further heated at 160° C. for 6 hours to carbonize the sucrose; to the thus carbonized sample, 0.8 g of sucrose, 0.09 g of 97% sulfuric acid and 5 ml of distilled water were again added and the mixture thus obtained was heated at 100° C. for 6 hours, and further heated at 160° C. for 6 hours to yield a composite material (SC1) of a silica/carbon material. The obtained composite material (SC1) of a silica/carbon material was calcined under an atmosphere of argon gas at 900° C. for 5 hours, the calcined sample thus obtained was put in 15 ml of an aqueous solution of sodium hydroxide having a concentration of 10 mol/L to dissolve the silica component, and the remaining solid content was filtered; the filtered solid content was washed and dried to yield a mesoporous carbon (CP1). The BET specific surface area of CP1 was found to be 1036 m²/g and the average diameter of the pores of CP1 was found to be 3.8 nm.

### Example 1

1. Production of a Carbon Composite Material Comprising Iron Oxide (Fe₂O₃) and the Carbon Material

By using ferrous sulfate heptahydrate (FeSO₄·7H₂O), ferrous chloride tetrahydrate (FeCl₂·4H₂O) and distilled water, a mixed aqueous solution of ferrous sulfate and ferrous chloride (the ferrous sulfate heptahydrate concentration: 400 g/L, the ferrous chloride tetrahydrate concentration: 160 g/L) was prepared. The aqueous solution was used as the following plating bath.

CP1 obtained in Production Example 1 and a binder (PTFE) were mixed together in a weight ratio of 95:5, and the mixture thus obtained was put in a die to be molded into a compacted powder pellet under a pressure of 200 MPa. The compacted powder pellet was fixed to a metal aluminum plate with a carbon tape, and immersed into the plating bath to serve as a cathode. Additionally, another metal aluminum plate was immersed into the plating bath to serve as an anode. The temperature of the plating bath was maintained at 40° C., and a constant current of 285 mA was applied between the anode and the cathode with a galvanostat for 1710 seconds to conduct electrolysis (plating). Thereafter, the compacted powder pellet was taken out of the plating bath, pulverized, washed with distilled water and dried, and thereafter the same operation (the operation in which a compacted powder pellet was obtained by molding, and the same constant current electrolysis (plating) as described above was conducted) as described above was repeated four times. As described above, the plating was conducted five times in total, thereafter the compacted powder pellet was pulverized, the powder thus obtained was subjected to a heat treatment in a flow of oxygen gas at 250° C. for 1 hour to oxidize the plating layer, and a carbon composite material (FCP1) comprising iron oxide (Fe₂O₃) and the carbon material was obtained. FCP1 was subjected to a measurement of the nitrogen gas adsorption/desorption isotherm, and the rise of the curve due to the mesoporous origin was found to level off, and hence a coating layer was found to be formed in the pores of the mesoporous carbon. Additionally, the BET specific surface area of FCP1 was found to be 452 m²/g and the average diameter of the pores of FCP1 was found to be 2.4 nm. From the SEM-EDX measurement of FCP1, the presence of iron on the surface of the FCP1 particles was verified. Further, from the powder X-ray diffraction measurement of FCP1, the diffraction peak derived from iron oxide (γ-Fe₂O₃) was identified and hence the metal oxide which coats the surface of the mesoporous carbon was found to be iron oxide (γ-Fe₂O₃). FCP1 was also subjected to an ICP measurement and consequently the iron oxide content was found to be 30% by weight.

### 2. Charge-discharge Test Based on a Coin Cell

FCP1 obtained as described above and a binder (PTFE) were mixed together in a weight ratio of 95:5, the mixture obtained was put in a die to be molded into a compacted powder pellet under a pressure of 200 MPa to yield an electrode sample 1. The electrode sample 1, a solution (LiPF₆/EC+DEC), as an electrolytic solution, prepared by dissolving LiPF₆, so as to have a concentration of 1 mol/L, in a mixed solution of ethylene carbonate (EC) and diethyl carbonate (DEC) in a volume ratio of 30:70, a polyethylene porous film as a separator and a piece of lithium metal as a counter electrode were combined to produce a coin cell 1. By using the coin cell 1, at a temperature maintained at 25° C., under the charge-discharge conditions in the following order, a constant-current charge-discharge test was conducted.

### (Charge-discharge Conditions)

Discharge minimum voltage: 1.0 V, discharge current: 0.5 mA/cm²

Charge maximum voltage: 4.0 V, charge current: 0.5 mA/cm²

In the above-described charge-discharge test, when the initial discharge capacity (mAh/g) was represented by 100, the initial charge capacity was found to be 71, and the coin cell 1 was found to have the smaller irreversible capacity and the smaller rate of the capacity loss due to the irreversible capacity.

### Comparative Example 1

A coin cell 2 was produced in the same manner as in Example 1 except that CP1 obtained in Production Example 1 was used in place of FCP1. By using the coin cell 2, at a temperature maintained at 25° C., under the charge-discharge conditions in the following order, a constant-current charge-discharge test was conducted.

### (Charge-discharge Conditions)

Discharge minimum voltage: 0.3 V, discharge current: 0.5 mA/cm²

Charge maximum voltage: 3.0 V, charge current: 0.5 mA/cm²

In the above-described charge-discharge test, when the initial discharge capacity (mAh/g) was represented by 100, the initial charge capacity was found to be 24, and the coin cell 2 was found to have the larger irreversible capacity and the larger rate of the capacity loss due to the irreversible capacity.

### INDUSTRIAL APPLICABILITY

According to the carbon composite materials of the present invention, it is possible to obtain electrodes having a smaller rate of the capacity loss due to the irreversible capacity in the initial cycle in the charge-discharge cycle test, as compared with the electrodes comprising conventional carbon materials. Accordingly, such electrodes are suitably usable in secondary batteries, in particular, nonaqueous electrolytic solution secondary batteries such as lithium ion secondary batteries, and are also usable as electrodes for capacitors and as electrodes for fuel cells; thus the present invention is industrially extremely useful.

1. A carbon composite material comprising a carbon material and a metal oxide coating on a surface of the carbon material, wherein the metal oxide is an Fe-containing metal oxide.

2. The carbon composite material according to claim 1, wherein the carbon material is a mesoporous carbon.

3. The carbon composite material according to claim 1, wherein the Fe-containing metal oxide is Fe₂O₃.

4. The carbon composite material according to claim 1, wherein a BET specific surface area of the carbon composite material is 400 m²/g to 1000 m²/g.

5. The carbon composite material according to claim 1, wherein the carbon composite material has pores and an average diameter of the pores is 1 nm to 10 nm.

6. A process for production of the carbon composite material according to claim 1 comprising the following steps of (a) and (b):
(a) a step of obtaining an Fe-coated carbon material by coating a surface of a carbon material with Fe by an electrolysis using an anode, a cathode with the carbon material disposed on the surface thereof, and an electrolytic solution comprising an Fe-containing aqueous solution; and
(b) a step of heating the Fe-coated carbon material in an oxygen-containing atmosphere.

7. The process for production according to claim 6, wherein the anode and the cathode are each an Al plate.

8. An electrode comprising the carbon composite material according to claim 1.

9. An electrode comprising the carbon composite material obtained by the process for production according to claim 6.
